(19) United States
(12) Patent Application Publication
(10) Pub. No.: US 2022/0256782 A1
(43) Pub. Date: Aug. 18, 2022

(54) Restoration Material, Restoration Method for Abandoned Ion-absorbed Rare Earth Tailings Area and Use Thereof

(71) Applicant: Jiangxi Academy of Eco-environmental Sciences and Planning, Jiangxi (CN)

(72) Inventors: Meng ZHANG, Jiangxi (CN); Yanli SHI, Jiangxi (CN); Bing FENG, Jiangxi (CN); Na YAO, Jiangxi (CN); Qipei WANG, Jiangxi (CN); Mingshu LI, Jiangxi (CN); Zugen LIU, Jiangxi (CN); Ming CHEN, Jiangxi (CN)

(73) Assignee: Jiangxi Academy of Eco-environmental Sciences and Planning, Jiangxi (CN)

(21) Appl. No.: 17/549,350

(22) Filed: Dec. 13, 2021

Related U.S. Application Data
(63) Continuation of application No. PCT/CN2011/113741, filed on Aug. 20, 2021.

(30) Foreign Application Priority Data
Feb. 18, 2021 (CN) 202110190199.9

(51) Int. Cl. A01G 18/10; A01G 18/20; B09C 1/10

(52) U.S. Cl. CPC A01G 18/10; B09C 2101/00; B09C 1/105; A01G 18/20

(57) ABSTRACT

Disclosed is a restoration material, a restoration method for abandoned ion-absorbed rare earth tailings area and use thereof, which belongs to the technical field of ecological restoration. The restore material for the abandoned ion-absorbed rare earth tailings area provided by the present disclosure comprises AM fungi and pioneer plants; the species of AM fungi is selected from one or more of G. intraradices, G. mosseae and P. occultum; the pioneer plants is selected from one or more of paspalum, ramie and awn.

### CROSS REFERENCE TO EARLIER-FILED APPLICATION(S)

This patent application claims the benefit and priority and is a continuation of PCT/CN2021/113741 filed Aug. 20, 2021, which claims the benefit of Chinese Patent Application No. 202110190199.9 filed Feb. 18, 2021, the entire disclosures of which are hereby incorporated by reference.

### TECHNICAL FIELD OF THE INVENTION

The present disclosure belongs to the technical field of ecological restoration, and specifically relates to a restoration material, a restoration method for abandoned ion-absorbed rare earth tailings area and use thereof.

### BACKGROUND OF THE INVENTION

Ion-absorbed rare earth is a national strategic resource, which is non-renewable and is widely used in national defense construction and high-tech fields. The Gannan region of Jiangxi Province is rich in ion-absorbed rare earth resources and is known as “Rare Earth Kingdom” in China. The amount of ion-absorbed rare earths owned by Ganzhou City, Jiangxi Province account for 30% of those in China, and is currently attracting attention domestic and abroad. The mining of rare earths in southern Jiangxi began in the 1970s to 1980s, and generally experienced three mining processes: pool leaching, heap leaching and in situ leaching. Rare earth mining not only creates high profits but also causes a series of ecological and environmental problems such as the destruction of vegetation and land resources, and water and soil pollution. Especially since the 1990s, the use of in situ leaching technique to extract rare earth elements has caused the most serious water and soil pollution problems in the mining area and periphery areas.

The field investigations showed that the soil was porous, soil desertification was severe, and nothing growed in the area seriously affected by the mining of ion-absorbed rare earth mines in Gannan region. During the southern rainstorm season, the abandoned rare earth mines in Gannan region were prone to water and soil erosion, resulting in a large amount of abandoned slopes, and serious geological disasters such as sink, collapse, and landslide caused by unstable slopes, bare surface, and lack of vegetation, which severely restricted and impeded regional agricultural and social development. Therefore, in view of the destruction of ion-absorbed rare earth mines to the surrounding environment, it is urgent to carry out ecological reconstruction of the ion-absorbed rare earth tailings mining area in Gannan region.

### SUMMARY OF THE INVENTION

In order to solve the above problems, the present disclosure provides restoration material, restoration method for ion-absorbed rare earth tailings mining area and use thereof. The restoration material for the ion-absorbed rare earth tailings mining area provided by the present disclosure can effectively improve the extremely degraded ecological environment caused by the abandoned tailings of the ion-absorbed rare earth mines and improve the soil degradation and environmental pollution in the mining area caused by the destruction of the rare earth mines.

In order to achieve the above objects, the present disclosure provides the following technical schemes:

The present disclosure provides restoration materials for ion-absorbed rare earth tailings, which include arbuscular mycorrhizal (AM) fungi and pioneer plants.

The species of the AM fungi is selected from one or more of Glomus intraradices, G. mosseae, and Paraglomus occultum.

The species of pioneer plants is selected from one or more of paspalum, ramie and awn.

In some embodiments, the AM fungus is used after propagation and cultivation, and the propagation and cultivation method comprises the following steps: propagating and culturing the seedlings of host plant having been infected with the AM fungi, after propagating and culturing, taking rhizosphere soil containing AM fungi spores, extraroot hyphae and the root segments of infected host plants to obtain propagated AM fungi.

In some embodiments, the host plant includes Sorghum sudanense (Piper) Stapf.

In some embodiments, the infection method comprises the following step(s): carrying out root impregnation to the seedlings of the host plant after 2 weeks of growth.

In some embodiments, a substrate for propagation and cultivation includes red soil, coarse sand and fine sand, wherein the mass ratio of red soil to coarse sand to fine sand in the substrate is (3-5):(1-2):1.

In some embodiments, a time for propagation and cultivation is 60-90 days.

The present disclosure provides a restoration method for ion-absorbed rare earth tailings mining area, using the restoration material described in the above technical scheme for restoration.

In some embodiments, the restoration method comprises the following steps: inoculating AM fungi into ion-absorbed rare earth tailings sand; sowing seeds of pioneer plants on the ion-absorbed rare earth tailings inoculated with AM fungi to realize the symbiosis of AM fungi and pioneer plants to restore the ion-absorbed rare earth tailings mining area.

In some embodiments, a seeding density of the pioneer plants is in range of 150 to 300 seeds/m².

The present disclosure provides use of the restoration material described in the above technical scheme in the restoration of ion-absorbed rare earth tailings mining area.

### Beneficial Effects

The present disclosure provides restoration material for ion-absorbed rare earth tailings mining area, which includes AM fungi and pioneer plants; wherein the species of AM fungi is selected from one or more of G. intraradices, G. mosseae and P occultum; the pioneer plants is selected from one or more of paspalum, ramie and awn. The pioneer plants in the present disclosure have good stress resistance, grow well under the conditions of the salinization and acidification of slag and harsh environment, have a good restoration effect on the ion-absorbed rare earth tailings mining area. AM fungi can further improve stress resistance to high salt and high acid and the tolerance to heavy metals of the pioneer plants, which improves the restoration effect of pioneer plants on abandoned ion-absorbed rare earth mines. When the restoration material provided by the present disclosure is used for the restoration of ion-absorbed rare earth tailings mining areas, it has the characteristics of high plant restoration success rate, excellent effect, and ability to significantly reduce the rate of soil erosion, and has good effect on vegetation ecological restoration in abandoned ion-absorbed rare earth tailings mining areas in the rainy area in the south, suitable for the rapid treatment of abandoned rare earth tailings mining areas in rainy areas in the south.

### DETAILED DESCRIPTION OF THE INVENTION

The present disclosure provides restoration material for ion-absorbed rare earth tailings, which includes AM fungi and pioneer plants; The species of the AM fungi is selected from one or more of G. intraradices, G. mosseae and P. occultum; the species of pioneer plants is selected from one or more of paspalum, ramie and awn. When the restoration material provided by the present disclosure is used to the restoration of ion-absorbed rare earth tailings, it has the characteristics of high plant restoration success rate, excellent effect, and ability to significantly reduce the rate of soil erosion, and has good effect of vegetation ecological restoration in ion-absorbed rare earth tailings areas in the rainy area in the south, suitable for the rapid treatment of abandoned rare earth tailings areas in rainy areas in the south.

In the present disclosure, the species of the AM fungi is selected from one or more of G. intraradices, G. mosseae and P. occultum. In the examples of the present disclosure, the G, intraradices, G. mosseae and P. occultum are preferably purchased from the Institute of Plant Nutrition, Resources and Environment, Beijing Academy of Agriculture and Forestry Sciences. The strain number of G, intraradices is 1511C0001BGCAM0030, the strain number of G, mosseae is 1511C001BGCAM0010, and the strain number of the P, occultum is 1511C0001BGCAM007.

The inoculation rate of the AM fungus of the present disclosure to the roots of pioneer plants is over 80%, and the symbiotic relationship is good. The AM fungi also have obvious promoting effects on the growth of pioneer plants and the content of physical and chemical indexes in the rhizosphere soil, which can significantly improve the survival rate and biomass of pioneer plants, improve the resistance to high salt and high acid and the tolerance to heavy metals of pioneer plants, improve the physical and chemical indexes of rhizosphere soil, and increase the restoration effect of pioneer plants to abandoned ion-absorbed rare earth mines.

In the present disclosure, the AM fungus is preferably used after propagation and cultivation, and the propagation and cultivation method preferably includes the following steps: propagating and culturing the seedlings of host plant having been infected with the AM fungi, and, after propagating and culturing, taking rhizosphere soil containing AM fungi spores, extraroot hyphae and the root segments of infected host plants to obtain propagated AM fungi.

In the present disclosure, the host plant for propagation and cultivation preferably includes Sorghum sudanense (Piper) Stapf. S. sudanense (Piper) Stapf and the AM fungi of the present disclosure have a good symbiotic relationship, and the propagation effect is good. The substrate for propagation and cultivation preferably includes red soil, coarse sand and fine sand, wherein the mass ratio of red soil to coarse sand to fine sand in the substrate is preferably (3-5): (1-3):1, more preferably 3:1:1. The substrate has the characteristics of good air permeability and provides a good living environment and nutrients for S. sudanense (Piper) Stapf. The substrate is preferably sterilized before use, and the sterilization conditions are preferably sterilization by exposure to heat at 121° C. for 2 hours. Sterilizing the substrate can prevent substrate contamination to avoid adverse effects on the growth of S. sudanense (Piper) Stapf and AM fungi.

In the present disclosure, the seeds of the host plants are preferably infected with AM fungi when being grown into seedlings after sowing. The seedlings of the host plants are preferably infected after 2 weeks of growth.

After the infection, the host seedlings after infection preferably transplanted into a sterilized substrate for propagation and cultivation in the present disclosure. The time of propagation and cultivation is preferably 60 to 90 days, or more preferably 60 days.

After propagation and cultivation, the rhizosphere soil containing the AM fungus spores, extra-rhizoic hyphae and the roots of the inoculated host plant is taken in the present disclosure to obtain the propagated AM fungi.

In the present disclosure, the species of the pioneer plants is selected from one or more of paspalum, ramie and awn. In the present disclosure, there is no special requirements on the source of pioneer plants; the above-mentioned pioneer plant varieties conventionally obtained in the art will do. The pioneer plants in the present disclosure have good stress resistance, grow well under the conditions of salinization and acidification of slag and harsh environment, and have a good restoration effect on the ion-absorbed rare earth tailings area.

The present disclosure provides a restoration method for ion-absorbed rare earth tailings area, using the restoration material described in the above technical scheme for restoration.

In the present disclosure, the restoration method preferably includes the following steps: inoculating AM fungi into ion-absorbed rare earth tailings sand; sowing the seeds of pioneer plants on the ion-absorbed rare earth tailings inoculated with AM fungi to realize symbiosis of AM fungi and pioneer plants to restore ion-absorbed rare earth tailings area.

In the present disclosure, the inoculation amount of the AM fungi to the ion-absorbed rare earth tailings sand is preferably 50-200 g AM fungi/kg tailings sand, and more preferably 100 g AM fungi/kg tailings sand. In the present disclosure, the seeding density of the pioneer plants is preferably 150 to 300 seeds/m², more preferably 200 seeds/m².

After planting, the technical scheme of the present disclosure also preferably includes field moisture and fertilization management. In the present disclosure, there is no special restrictions on the specific operations of field moisture and fertilization management, and methods well known to those skilled in the art will do, such as topdressing 1 time after watering 2˜6 times, and topdressing in accordance with 1/10 of the amount of base fertilizer; after the plants grow for 60 to 180 days, the plants are harvested, and determine the relevant indexes after drying. If the dried plants meet the “GB 13078 Feed Hygiene Standard”, they can be used as livestock feed. If they do not meet relevant standards, they will be transferred to centralized incineration and harmless treatment.

The restoration method provided by the present disclosure has the characteristics of high success rate of plant restoration, excellent effect, and ability to significantly reduce soil erosion rate. It has a good effect on vegetation ecological restoration in abandoned ion-absorbed rare earth tailings areas in rainy areas in the south, and is suitable for rapid treatment of abandoned rare earth tailings area in rainy areas in the south; meanwhile, the restoration method provided by the present disclosure has the advantages of simple technical process, easy construction, beautiful and safe appearance, easy promotion and application, and has broad application prospects and market demands.

The present disclosure provides use of the restoration material described in the above technical scheme in the restoration of ion-absorbed rare earth tailings area. The restoration material or restoration method for the ion-absorbed rare earth tailings area provided by the present disclosure can effectively improve the extremely degraded ecological environment caused by the abandoned tailings of the ion-absorbed rare earth mining area and improve the soil degradation and environmental pollution in the mining area caused by the destruction of rare earth mines.

In order to further illustrate the present disclosure, the restoration materials, restoration methods for ion-absorbed rare earth tailings area and use provided by the present disclosure will be described in detail below with reference to examples, but they should not be understood as limiting the protection scope of the present disclosure.

### EXAMPLE 1

A restoration material for ion-absorbed rare earth tailings area was composed of AM fungi and paspalum, in which the species of AM fungi was P. occultum, purchased from the Institute of Plant Nutrition Resources and Environment, Beijing Academy of Agriculture and Forestry Sciences, Strain number 1511C0001BGCAM007; Paspalum seeds were purchased from Scarecrow Agricultural Park, Xinyu City, Jiangxi Province.

The propagation and cultivation method of AM fungi was as follows.

The seedlings of host plant having been infected with the AM fungus were propagated and cultured. The host plant was S. sudanense (Piper) Stapf. The substrate for propagation and cultivation was red soil, coarse sand and fine sand mixing in a mass ratio of 3:1:1. The propagation substrate was sterilized at 121° C. for 2 h. First, the seeds of the S. sudanense (Piper) Stapf were sown in the sterilized propagation medium. After 2 weeks, the seedlings were taken out, the roots were washed clean, and then the AM fungi was evenly inoculated to the roots of the seedlings, and the seedlings after inoculating were planted in the sterilized substrate to propagate and culture for 3 months, after propagating and culturing, the rhizosphere soil containing AM fungi spores, extra-rhizoic hyphae and roots of the inoculated host plant was taken to obtain the propagated AM fungi.

A restoration method of ion-absorbed rare earth tailings mining area included the following.

The paspalum seeds were washed with deionized water, the paspalum seeds were disinfected in surface with 10% H₂O₂ (aqueous) for 10 minutes, and then the paspalum seeds were rinsed with sterile water (distilled water in an autoclave at 121° C. for 20 minutes) until they were clean and tasteless.

The AM fungi after propagation and cultivation were inoculated into ion-absorbed rare earth tailings sands, the inoculation amount was 100 g AM fungi/kg tailings sand substrate, and then the sterilized pioneer plant paspalum seeds (selected seeds of full-grained with 200 seeds/m²) were sown in holes, each hole (7-10 cm diameter), and were covered with 200 g tailings sand substrate. Two weeks after the seedlings were germinated, nitrogen, phosphorus and potassium fertilizers were added every 1 week with 1/10 diluted Hongland solution, and the base of seedlings was sprayed for 1-2 times; After 2 months of growth, the plants were harvested. The present disclosure utilizes the symbiosis of AM fungi and pioneer plants to restore the ion-absorbed rare earth tailings mining area.

### EXAMPLE 2

A restoration material for ion-absorbed rare earth tailings mining area, was composed of AM fungi and paspalum, in which the species of AM fungi was G. mosseae, purchased from the Institute of Plant Nutrition Resources and Environment, Beijing Academy of Agriculture and Forestry Sciences, Strain number 1511C001BGCAM0010; Paspalum was purchased from Scarecrow Agricultural Park, Xinyu City, Jiangxi Province.

The propagation and cultivation method of AM fungi and the restoration method of ion-absorbed rare earth tailings area were the same as those in Example 1, except that the species of AM fungi was G. mosseae.

### EXAMPLE 3

A restoration material for ion-absorbed rare earth tailings area, was composed of AM fungi and paspalum, in which the species of AM fungi was G. intraradicus, purchased from the Institute of Plant Nutrition Resources and Environment, Beijing Academy of Agriculture and Forestry Sciences, Strain number 1511C0001BGCAM0030; Paspalum was purchased from Scarecrow Agricultural Park, Xinyu City, Jiangxi Province.

The propagation and cultivation method of AM fungi and the restoration method of ion-absorbed rare earth tailings area were the same as those in Example 1, except that the species of AM fungi was G. intraradicus.

### Comparative Example 1

A restoration method for ion-absorbed rare earth tailings area. The specific steps were the same as those in Example 1, except that the paspalum was not injected with AM fungus.

### Application Example 1

### Effect Evaluation

Location: Donghu District, Nanchang City, Jiangxi Province—In the Scientific Research Laboratory in Jiangxi Academy of Environmental Sciences

Source of test soil: Daluoshi abandoned ion-absorbed rare-earth tailings in Wenfeng Town, Xunwu County, Ganzhou City, Jiangxi Province

Time: From September to November 2019

The basic physical and chemical index content of the tailings substrate was as follows: total phosphorus 100.0 mg/kg, total nitrogen 170.0 mg/kg, nitrate nitrogen 7.12 mg/kg, ammonium nitrogen 18.4 mg/kg, organic matter 2.61 g/kg, pH 4.38, lanthanum 608.0 mg/kg, yttrium 114.0 mg/kg and europium 16.8 mg/kg.

The soil required for propagation was taken from hilly red soil in Donghu District, Nanchang City, Jiangxi Province (red soil around camellia trees, sterilized at 121° C. for 2 hours before use). The sterilized tailings sand and soil were put into a test basin (a plastic basin with an upper diameter of 14 cm, a lower inner diameter of 7 cm, and a height of 9 cm) for planting paspalum.

Test scheme: In this test, four treatment levels were set. The restoration methods of Examples 1 to 3 and Comparative Example 1 were used to perform ex-situ restoration of tailings from the abandoned rare earth mining area in Daloshi, Wenfeng Town, Xunwu County, Ganzhou City, Jiangxi Province. There were 6 parallels for each treatment. A total of 60 basins were planted in this test and randomly placed indoors. The plants were harvested after 2 months of growth. After harvest, the roots were cleaned, and the aboveground plant length, underground root length, total fresh weight, total number of plants, total chlorophyll concentration were determined, and some plant roots were taken to determine mycorrhizal inoculation rate, the test results were shown in Table 1; samples of rhizosphere tailings sand substrate were collected for soil physical and chemical indexes and enzyme activity determination. The test results were shown in Tables 2 to 4.

The specific detection methods were as follows.

The total chlorophyll concentration was determined by the spectrophotometric method of Wintermans & De Mots (1965) (Reference: Wintermans J F G M, De Mots, A. Spectrophotometric characteristics of chlorophylls a and b and their pheophytins in ethanol [J]. Biochimica et Biophysica Acta, 1965, 109(2):448-453).

The mycorrhizal infection rate of plant roots was determined by the Trypan Blue Staining method. The roots of the plants were cut into root segments with the length of 1 cm and placed in a test tube, 5%-10% KOH solution was added, and the test tube was placed in a 90° C. water bath to decolorize (60 min), after the decolorization was completed, the solution was removed, the root segments were rinse with deionized water several times, 2% HCl solution was added to soak for 5 minutes, the acid solution was removed, and then 0.05% trypan blue staining solution was added (lactic acid: glycerin: water was 1:1:1). The test tube was put back in a 90° C. water bath for dyeing for 60 minutes, and deionized water was used to rinse for several times after dyeing. The stained roots were put under a microscope to observe the mycorrhizal tissue structure and the number of infected root segments. The infection rate was calculated as follows: Infection rate=number of root segments infected by mycorrhiza/total number of observed root segments×100%.

Rhizosphere soil nitrogenase activity was determined with soil nitrogenase enzyme-linked immunoassay kit, protease activity was determined with soil protease ELISA test kit, urease activity was determined with soil urease ELISA test kits, and all kits used were purchased from Wuhan Boshikang Biological Engineering Co., Ltd.

The determination method of soil physical and chemical index referred to “Analytical methods of soil agricultural chemistry” compiled by Lu Rukun (2000). Soil pH was determined by potentiometric method; potassium dichromate oxidation colorimetric method was used to determine organic matter; cation exchange capacity was determined by using barium chloride-magnesium sulfate; available potassium was determined by sodium tetraphenyl boron turbidimetric method; effective phosphorus was determined by using hydrochloric acid-ammonium fluoride; ammonium nitrogen was determined by indophenol blue colorimetry; total phosphorus in rhizosphere soil of potted plants was determined by determination of forest soil phosphorus LY/T 1232-2015, total nitrogen, ammonia nitrogen and nitrate nitrogen were determined by determination of forest soil nitrogen LY/T 1228-2015; heavy metal elements cadmium (Cd), copper (Cu), zinc (Zn), lead (Pb) and rare earth elements lanthanum (La), yttrium (Y), europium (Eu) content were determined by determination of silicate rock chemical analysis method according to GB/T 14506.30-2010; mercury (Hg) content was determined by atomic fluorescence method according to GB/T 22105.1-2008.

TABLE 1
Statistical table of the effects of different treatments
on the infection rate and biomass of paspalum roots

| | Infection | Plants | Above ground | Underground | Fresh | |
|---|---|---|---|---|---|---|
| | rate | Number | plant length | root length | weight | Chlorophyll |
| Treatment | (%) | (ind.) | (cm) | (cm) | (g) | a(mg/g) |
| Comparative | 0 | 26 ± 4.03 | 10 ± 0.88 | 1.2 ± 0.03 | 0.88 ± 0.24 | 16.83 ± 0.17 |
| Example 1 | | | | | | |
| Example 1 | 80 ± 2.54 | 30 ± 7.44 | 11.3 ± 1.13 | 1.3 ± 0.42 | 1.67 ± 0.36 | 67.30 ± 0.34 |
| Example 2 | 83 ± 5.5 | 39 ± 5.26 | 13 ± 1.05 | 1.17 ± 0.16 | 2.25 ± 0.41 | 76.13 ± 3.69 |
| Example 3 | 83 ± 1.13 | 74 ± 8.97 | 16 ± 1.04 | 1.4 ± 0.06 | 3.66 ± 0.66 | 82.44 ± 4.87 |

The values in the table are the mean ± standard error.

It can be seen from the results in Table 1 that the AM fungi and paspalum of Examples 1 to 3 had a good symbiotic relationship, and the infection rate could reach more than 80%; Compared with Comparative Example 1, the number of live paspalum plants, above-ground plant length, underground roots length, and the fresh weight of Examples 1 to 3 in the present disclosure were significantly increased. In particular, the effect on the growth of paspalum in Example 3 was the most obvious. The averages of plants number, aboveground plant length, underground root length and fresh weight were 2.8 times, 1.6 times, 1.17 times and 4.16 times of those in Comparative Example 1, respectively.

It can also be seen from the results in Table 1 that the chlorophyll content in Examples 1 to 3 was higher than that in Comparative Example 1 (16.83 mg/g), especially chlorophyll content (82.44 mg/g) was highest in Example 3, which was 4.9 times that of Comparative Example 1. The level of chlorophyll content could not only indicate the nutritional status of plants, but also could be an indicator of the disturbance and stress state of plants by the external environment, reflecting the production capacity of plants. The results in Table 1 show that AM fungi could increase nutrient elements such as N and P in the paspalum rhizosphere tailings sands substrate, expand the area of plant roots to absorb nutrients, thereby promoting chlorophyll synthesis and increasing the chlorophyll content. The AM fungus of the present disclosure can play a good role in promoting the growth of the pioneer plant paspalum in the ion-absorbed rare earth tailings mining area, and in particular, the effect on the increase in the biomass of paspalum was most obvious in Example 3.

TABLE 2
Statistical table of the effect of different treatments on the
enzyme activity of paspalum rhizosphere tailings sand substrate

| | Nitrogenase activity | Protease activity | Urease activity |
|---|---|---|---|
| Treatment | (U/L) | (U/L) | (U/L) |
| Comparative | 476.23 ± 8.34 | 4253.71 ± 402.11 | 1785.98 ± 78.39 |
| Example 1 | | | |
| Example 1 | 471.0 ± 13.49 | 5804.49 ± 496.13 | 2078.48 ± 188.00 |
| Example 2 | 455.73 ± 15.39 | 8363.08 ± 605.46 | 2610.98 ± 189.16 |
| Example 3 | 481.48 ± 6.79 | 6222.46 ± 576.74 | 1949.73 ± 102.56 |

The values in the table were the mean ± standard error.

From the results in Table 2, it can be seen that the average nitrogenase activity (481.48 U/L) in the tailings sand substrate of Example 3 was higher than that of Comparative Example 1 (476.23 U/L), but the difference between the two was relatively small; The average value of nitrogenase activity in the tailings sand substrate of the slags in Examples 1-2 were lower than that of Comparative Example 1. It was not obvious advantages shown in Examples 1 to 3 compared with Comparative Example 1, indicating that the inoculation of AM fungi of Examples 1-3 had little effect on nitrogenase activity in paspalum rhizosphere tailings substrate.

By measuring the protease and urease activities in the tailings sand substrate of paspalum rhizosphere in different treatment groups, the results showed that average value of the protease activity and urease activity of the tailings sand substrate in Examples 1 to 3 were higher than those in Comparative Example 1. Especially, the promotion effect on the protease and urease activities of the tailings sand substrate in Example 2 was the most obvious, and the average values of which were 1.97 times and 1.46 times that of Comparative Example 1, respectively. Inoculating the AM fungi of Examples 1-3 in the tailings sand of ion-absorbed rare earth tailings mining area could increase the protease and urease activities of tailings sand substrate, so that the restoration effect was improved.

TABLE 3
Statistical table of the effects of different treatments on the
nitrogen content of paspalum rhizosphere tailings sand substrate

| | Total nitrogen | Nitrate nitrogen | Ammonia nitrogen |
|---|---|---|---|
| Treatment | (mg/kg) | (mg/kg) | (mg/kg) |
| Comparative | 155.0 ± 0.01 | 7.690 ± 1.65 | 19.90 ± 1.63 |
| Example 1 | | | |
| Example 1 | 300.0 ± 0.01 | 6.185 ± 1.46 | 22.35 ± 1.52 |
| Example 2 | 205.0 ± 0.02 | 5.450 ± 1.30 | 29.40 ± 2.04 |
| Example 3 | 245.0 ± 0.02 | 5.905 ± 0.85 | 26.75 ± 1.66 |

The values in the table were the mean ± standard error.

It can be seen from Table 3 that compared with Comparative Example 1, the content of total nitrogen and ammonia nitrogen in the rhizosphere tailings sand substrate were increased in Examples 1 to 3, and reduce the content of nitrate nitrogen, indicating that the AM fungi in Examples 1 to 3 could promote the formation of inorganic nitrogen and ammonium nitrogen in tailings sand substrate, transform the nitrogen in the tailings sand substrate into ammonia nitrogen that could be directly used for plant growth, thereby providing the nitrogen needed for growth and development of paspalum, and also playing the role of removing nitrogen pollutants in the tailings sand substrate.

TABLE 4
Statistical table of the effects of different treatments on organic
matter and total phosphorus content of paspalum rhizosphere tailings

| | Total phosphorus | Organic matter |
|---|---|---|
| Treatment | (mg/kg) | (g/kg) |
| Comparative | 110.0 ± 0.02 | 2.48 ± 0.65 |
| Example 1 | | |
| Example 1 | 140.0 ± 0.35 | 3.60 ± 1.02 |
| Example 2 | 130.0 ± 0.21 | 2.06 ± 0.30 |
| Example 3 | 112.0 ± 0.01 | 2.90 ± 0.68 |

The values in the table were the mean ± standard error.

From the results in Table 4, it can be seen that the total phosphorus content in Comparative Example 1 was the lowest, which was 110.0 mg/kg. The total phosphorus content in Examples 1 to 3 was shown as Example 1>Example 2>Example 3 from high to low. The total phosphorus content (100.0 mg/kg) in the tailings sand substrate before the pot experiment was lower than that in Comparative Example 1 and Examples 1 to 3; the organic matter content was the lowest in Example 2, and the organic matter content both in Example 1 and Example 3 were higher than those in Comparative Example 1. The organic matter content (2.61 g/kg) before the pot experiment in the tailings sand substrate was lower than that in Example 1 and Example 3, and higher than that in Comparative Example 1 and Example 2. In general, inoculation of the AM fungi in Examples 1 to 3 can increase the organic matter and total phosphorus content in the rhizosphere tailings sand substrate of paspalum, thereby promoting the absorption of phosphorus by paspalum, and increasing the survival rate and biomass of paspalum, thus improving the restoration effect.

It can be seen from the results of the above examples that the restoration material for abandoned ion-absorbed rare earth tailings provided by the present disclosure is able to significantly increase the survival rate and biomass of pioneer plants, increase the protease and urease activities of the mining sand substrate, and increase the content of phosphorus and organic matter in the mining sand substrate, improve the extremely degraded ecological environment caused by abandoned tailings of the ion-absorbed rare earth mines, and improve the soil degradation and environmental pollution in mining areas caused by the destruction of rare earth mines.

Although the above examples give a detailed description of the present disclosure, they are merely a part of the embodiments of the present disclosure, rather than all the embodiments. People can also obtain other embodiments based on this embodiment without being inventive. These embodiments shall all belong to the protection scope of the present disclosure.

What is claimed is:

1. A restoration material for abandoned ion-absorbed rare earth tailings, wherein the restoration material comprises arbuscular mycorrhizal fungi and pioneer plants; wherein
the species of the arbuscular mycorrhizal fungi is selected from one or more of Glomus intraradices, Glomus mosseae and Paraglomus occultum; and
the species of pioneer plants is selected from one or more of paspalum, ramie and awn.

2. The restoration material according to claim 1, wherein the arbuscular mycorrhizal fungus is used after propagation and cultivation, and the propagation and cultivation method comprises the following steps: propagating and culturing the seedlings of host plant having been infected with the arbuscular mycorrhizal fungi, and after propagating and culturing, taking rhizosphere soil containing arbuscular mycorrhizal fungi spores, extraroot hyphae and the root segments of infected host plants to obtain propagated arbuscular mycorrhizal fungi.

3. The restoration material according to claim 2, wherein the host plant comprises Sorghum sudanense (Piper) Stapf.

4. The restoration material according to claim 2, wherein the infection method comprises the following steps: carrying out root impregnation to the seedlings of the host plant after 2 weeks of growth.

5. The restoration material according to claim 2, wherein a substrate for propagation and cultivation comprises red soil, coarse sand and fine sand, wherein the mass ratio of red soil to coarse sand to fine sand in the substrate is (3-5):(1-2):1.

6. The restoration material according to claim 2, wherein the time for the propagation and cultivation is 60-90 days.

7. A restoration method for ion-absorbed rare earth tailings area, the method comprising: inoculating arbuscular mycorrhizal fungi into the ion-absorbed rare earth tailings sand; and sowing seeds of pioneer plants on the ion-absorbed rare earth tailings inoculated with arbuscular mycorrhizal fungi to realize the symbiosis of arbuscular mycorrhizal fungi and pioneer plants, thereby restoring the ion-absorbed rare earth tailings area.

8. The restoration method according to claim 7, wherein a seeding density of the seeds of the pioneer plants is in range of 150 to 300 seeds/m².

9. The restoration material according to claim 3, wherein the infection method comprises the following steps: carrying out root impregnation to the seedlings of the host plant after 2 weeks of growth.

10. The restoration method according to claim 7, wherein the arbuscular mycorrhizal fungus is used after propagation and cultivation, and the propagation and cultivation method comprises the following steps: propagating and culturing the seedlings of host plant having been infected with the arbuscular mycorrhizal fungi, and after propagating and culturing, taking rhizosphere soil containing arbuscular mycorrhizal fungi spores, extraroot hyphae and the root segments of infected host plants to obtain propagated arbuscular mycorrhizal fungi.

11. The restoration method according to claim 10, wherein the host plant comprises S. sudanense (Piper) Stapf.

12. The restoration method according to claim 10, wherein the infection method comprises the following step: carrying out root impregnation to the seedlings of the host plant after 2 weeks of growth.

13. The restoration method according to claim 10, wherein a substrate for propagation and cultivation comprises red soil, coarse sand and fine sand, wherein the mass ratio of red soil to coarse sand to fine sand in the substrate is (3-5):(1-2):1.

14. The restoration method according to claim 10, wherein the time for the propagation and cultivation is 60-90 days.

15. A method for restoring ion-absorbed rare earth tailings area, the method comprising:
in a substrate, propagating and culturing the seedlings of host plant having been infected with the arbuscular mycorrhizal fungi, and after propagating and culturing, taking rhizosphere soil containing arbuscular mycorrhizal fungi spores, extraroot hyphae and the root segments of infected host plants to obtain propagated arbuscular mycorrhizal fungi
inoculating the propagated arbuscular mycorrhizal fungi into the ion-absorbed rare earth tailings sand; and
sowing seeds of pioneer plants on the ion-absorbed rare earth tailings inoculated with arbuscular mycorrhizal fungi to realize the symbiosis of arbuscular mycorrhizal fungi and pioneer plants, wherein a seeding density of the seeds of the pioneer plants is in range of 150 to 300 seeds/m², thereby restoring the ion-absorbed rare earth tailings area.

16. The method of claim 15, wherein a) the substrate comprises red soil, coarse sand and fine sand, wherein the mass ratio of red soil to coarse sand to fine sand in the substrate is (3-5):(1-2):1; b) the propagating and cultivating is conducted for 60-90 days; c) a seeding density of the seeds of the pioneer plants is in range of 150 to 300 seeds/m²; d) the species of the arbuscular mycorrhizal fungi is selected from one or more of Glomus intraradices, Glomus mosseae and Paraglomus occultum; and/or e) the species of pioneer plants is selected from one or more of paspalum, ramie and awn.
